(19) United States
(12) Patent Application Publication
(10) Pub. No.: US 2003/0056098 A1
(43) Pub. Date: Mar. 20, 2003

(54) Electronic apparatus and wireless communication system

(75) Inventor: Tadahiro Aihara, Hachioji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/225,139

(22) Filed: Aug. 22, 2002

(30) Foreign Application Priority Data
Sep. 18, 2001 (JP) 2001-284104

(51) Int. Cl. H04L 9/00

(52) U.S. Cl. 713/168; 380/270

(57) ABSTRACT

An electronic apparatus includes a main body and a communication device which is removably attached to the main body. The communication device includes an antenna, a communication unit which executes communication with another electronic apparatus via the antenna, a memory which stores an authentication code, and an authenticating unit which reads the authentication code stored in the memory and executes an authentication process using the authentication code when the communication with the another electronic apparatus is executed by the communication unit.

### CROSS-REFERENCE TO RELATED APPLICATIONS

This application is based upon and claims the benefit of priority from the prior Japanese Patent Application No. 2001-284104, filed Sep. 18, 2001, the entire contents of which are incorporated herein by reference.

### BACKGROUND OF THE INVENTION

1. Field of the Invention

The present invention relates to an electronic apparatus having a wireless communication function and also to a wireless communication system.

2. Description of the Related Art

There are wire standards to connect a personal computer (PC) to a peripheral, including USB (Universal Serial Bus), IEEE1394 (IEEE: Institute of Electrical and Electronics Engineers), etc. When a cable compliant with such a wire standard is used, a PC can be connected to an external HDD (Hard Disk Drive) or CD drive (CD-ROM, CD-R or CD-RW) or a DVD-ROM drive (DVD-ROM, DVD-RAM, DVD-R or DVD-RW), which is not incorporated in the PC.

In the above case, only the devices (for example, the PC and the HDD) connected by the connection cable access each other. Since another PC or the like can never access them, a high level of security is retained. However, not only the cables connecting the devices but also power source cables for driving the devices must be connected to the devices. Generally, therefore, the devices are multi-cabled, resulting in complicated connection.

Further, even if the PC is of a type that can be carried during operation, such as a notebook PC, it can be moved by a very short distance, since the PC is cabled to a peripheral. If a long cable is used to move the PC by a long distance, this arrangement makes the connection further complicated in addition to the complication due to the multi-cabling of the power source cables mentioned above.

In recent years, a plurality of PCs are connected by a LAN (Local Area Network) in many homes. If a PC is connected to an external HDD, CD-ROM/R/RW drive, or the like, the PC can independently access the external device. Another PC connected to the LAN can also access the external device by using a file-sharing service of the OS of the PC (for example, a network sharing service). In this case also, the security level is as high as in the case of a single PC, since only the PCs connected to the LAN can access the external device.

However, in the LAN, the PCs are multi-cabled. Further, to access the external device, the PC directly connected to the external device must be on and communicate with the external device. In other words, even if the external device is on, another PC connected to the LAN cannot access the external device unless the PC directly connected thereto is on. Thus, the conventional LAN is not necessarily convenient.

### BRIEF SUMMARY OF THE INVENTION

Accordingly, it is an object of the present invention to provide an electronic apparatus and wireless communication system, to which a plurality of PCs can be easily connected, while avoiding cable multi-connection and retaining a high level of security.

According to one aspect of the present invention, there is provided an electronic apparatus comprising a main body; and a communication device which is removably attached to the main body, the communication device including an antenna, a communication unit which executes communication with another electronic apparatus via the antenna, a memory which stores an authentication code, and an authenticating unit which reads the authentication code stored in the memory and executes an authentication process using the authentication code when the communication with the another electronic apparatus is executed by the communication unit.

According to another aspect of the present invention, there is provided an electronic apparatus comprising a hard disk drive; an antenna provided to the hard disk drive; a communication unit which executes communication with another electronic apparatus via the antenna; a memory which stores an authentication code; and an authenticating unit which reads the authentication code stored in the memory and executes an authentication process using the authentication code when the communication with the another electronic apparatus is executed by the communication unit.

According to still another aspect of the present invention, there is provided an electronic apparatus comprising a main body; a hard disk drive; an antenna provided to the hard disk drive; a communication unit which executes communication with another electronic apparatus via the antenna; a memory card which is removably attached to the main body and stores an authentication code; and an authenticating unit which reads the authentication code stored in the memory card and executes an authentication process using the authentication code when the communication with the another electronic apparatus is executed by the communication unit.

According to still another aspect of the present invention, there is provided a wireless communication system comprising a communication unit which executes wireless communication with another electronic apparatus in compliance with Bluetooth; a memory which stores at least one of a Bluetooth address and a PIN (Personal Identification Number); and an authenticating unit which executes an authentication process using the at least one of the Bluetooth address and the PIN, when the communication unit receives a connection request from the another electronic apparatus.

According to still another aspect of the present invention, there is provided a wireless communication system comprising a communication unit which executes wireless communication with another electronic apparatus in compliance with Bluetooth; a memory which stores a Bluetooth address and a PIN (Personal Identification Number) according to the Bluetooth address; and an authenticating unit which, when the communication unit receives a connection request from the another electronic apparatus, executes a connection cut process if the connection request is a request by a Bluetooth address other than the Bluetooth address stored in the memory, and executes an authentication process using the PIN stored in the memory if the connection request is a request by the Bluetooth address stored in the memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the overall structure of a wireless communication system according to a first embodiment of the present invention;

FIG. 2 is a block diagram showing an example of the structure of an external HDD of the embodiment;

FIG. 3 is a block diagram showing an example of the structure of an SD card of the embodiment;

FIG. 4 is a flowchart showing connection and authentication operations in a case of using a PIN according to the embodiment;

FIG. 5 is a flowchart showing connection and authentication operations in a case of using a BD address and a PIN according to the embodiment;

FIG. 6 is a diagram showing a data format for registering a plurality of BD addresses according to the embodiment;

FIG. 7 is a block diagram showing an example of the structure of an external HDD according to a second embodiment of the present invention; and

FIG. 8 is a block diagram showing an example of the structure of a removable medium (media) according to a third embodiment of the present invention.

### DETAILED DESCRIPTION OF THE INVENTION

Embodiments of the present invention will now be described with reference to the drawings.

(First Embodiment)

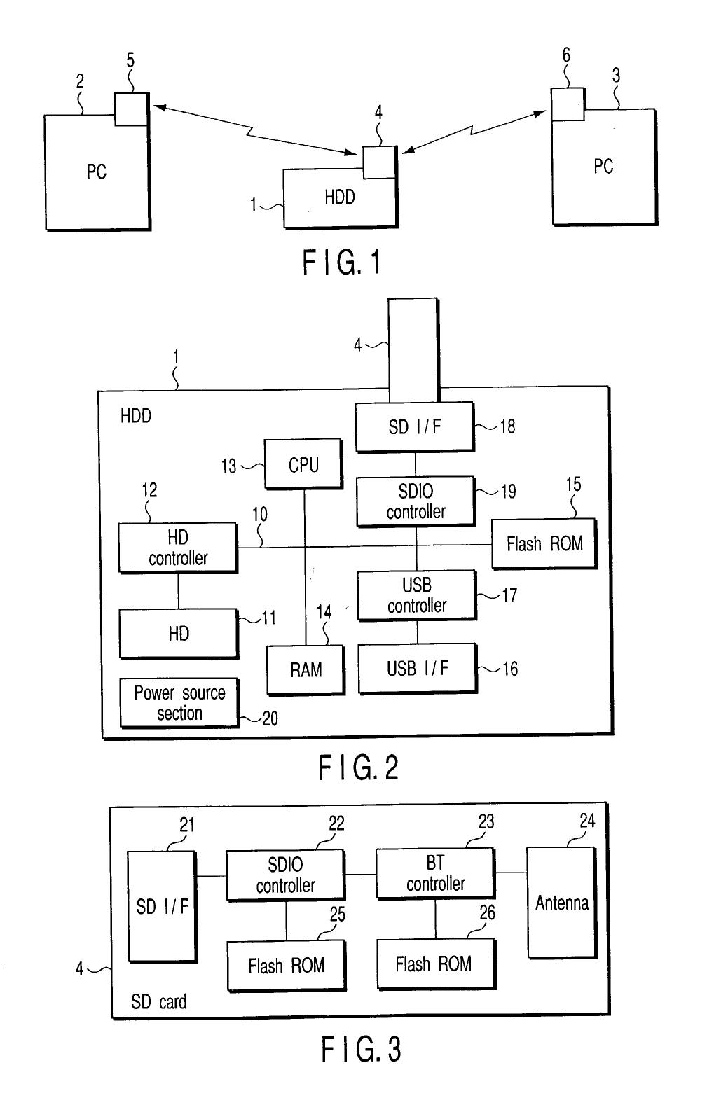

FIG. 1 is a schematic diagram showing a wireless communication system according to a first embodiment of the present invention. In the case shown in FIG. 1, an electronic apparatus, for example, an external HDD 1 is share-connected by first and second personal computers (PCs) 2 and 3.

The external HDD 1 uses a communication device, for example, an SD card 4, having communication functions in compliance with Bluetooth™, as an interface (I/F). The PCs 2 and 3 also use SD cards 5 and 6 having Bluetooth functions as interfaces.

The SD card 4 inserted in the HDD 1 prestores, i.e., registers authentication codes, such as a BD address (unique to Bluetooth) and PIN (Personal Identification Number), in the case of Bluetooth. On the sides of the PCs 2 and 3, BD addresses and PINs may be either prestored in the SD cards 5 and 6 or input through a keyboard or the like at a time of authentication.

Bluetooth is a wireless communication standard for a short distance. It realizes wireless communication normally within a range of 10 mm, in an ISM (Industry Science Medical) band of 2.4 GHz, and uses a frequency hopping method as a spectrum diffusion technique. According to Bluetooth, at most eight devices can be connected in a time divisional multiplexing manner.

When the SD card 4 is inserted in the HDD 1 or the HDD 1 is turned on with the SD card 4 inserted therein, the HDD 1 detects the SD card 4 and shifts to a standby state for responding to an inquiry from another Bluetooth device. Thereafter, the HDD 1 is kept in the standby state, and performs a connection process in response to an inquiry from another Bluetooth device, i.e., the PC 2 or 3.

The first PC 2 is connected to the HDD 1 via the SD card 5 and the SD card 4 inserted in the HDD 1. In this case, the first PC 2 operates as a master, while the HDD 1 operates as a slave. The first PC 2 makes an inquiry and a call to the HDD 1 as a Bluetooth device, and then it is connected to the HDD 1 after checking a response from the HDD 1.

After the connection to the HDD 1, the first PC 2 performs an authentication process based on the BD address and the PIN registered therein in advance or input by the user, by means of the security function of Bluetooth, thereby assuring security.

When the HDD 1 receives a connection request from the first PC 2, it performs an authentication process based on the prestored BD address and PIN.

After the connection process, the first PC 2 recognizes the HDD 1 as a removable device by means of an upper protocol stack and a File Transfer profile.

When the second PC 3 performs the same operation as that of the first PC 2, the HDD 1 is recognized as a removable device of the second PC 3. At this time, regardless of whether or not the first PC 2 is connected to the HDD 1, the second PC 3 can be connected to the HDD 1.

With the above method, multi-cabling is easily avoided, while a plurality of devices, such as PCs, can easily be connected to the HDD 1. In addition, a high level of security can be retained.

Detailed structures of the HDD 1 and the SD card 4 will now be described with reference to FIGS. 2 and 3.

FIG. 2 is a block diagram showing a structure of the HDD 1. The HDD 1 has a main body into which the SD card 4 is removably inserted. It includes an HD (hard disk) 11, an HD controller 12 which controls the HD 11, a CPU 13 which controls the overall operations, a RAM 14 which temporarily stores data, a flash ROM 15 which stores programs, a USB interface (USB I/F) 16, a USB controller 17, an SD interface (SD I/F) 18 for the SD card 4, an SDIO controller 19, and a power source section 20. The power source may be, for example, a battery, or a DC power source which converts commercial AC power to DC power.

The flash ROM 15 stores various protocols, such as HCI (Host Controller Interface), L2CAP (Logical Link Control and Adaptation Protocol), SDP (Service Discovery Protocol), profiles and programs necessary to control the HD 11.

The CPU 13 performs input/output processes through a bus line 10 among the HD controller 12, the USB controller 17 and the SDIO controller 19. The RAM 14 is a work area used when the CPU 13 executes processes.

FIG. 3 a block diagram showing an example of the structure of the SD card 4 inserted in the HDD 1. The SD card 4 includes an SD interface (SD I/F) 21, an SDIO controller 22, a Bluetooth controller (BT controller) 23, an antenna 24 for carrying out wireless communication with another Bluetooth device, a first flash ROM 25 connected to the SDIO controller 22 and a second flash ROM 26 connected to the BT controller 23.

The SD interface 21 serves as a connector to be connected to the SD interface 18 of the HDD 1. The HDD 1 accesses the SDIO controller 22 through the SD interface 21, and further accesses the BT controller 23 through the SDIO controller 22. The BT controller 23 has protocols of Bluetooth, such as HCI (Host Controller Interface), LM (Link Manager) and Baseband. The BT controller 23 processes control data from the host and outputs it as a high-frequency output to the antenna 24. It also processes a high-frequency signal from the antenna 24 and inputs/outputs control data or user data to/from the SDIO controller 22.

The first flash ROM 25 stores card information, and one or both of the BD address and the PIN as needed. The second flash ROM 26 stores programs which the BT controller 23 uses. When the power source is turned on, the BT controller 23 reads a program from the second flash ROM 23, and executes the corresponding process.

The BD address and the PIN may be written in the first flash ROM 25 by, for example, a PC or a PDA (Personal Digital Assistant), which has, for example, an SDIO interface. The Bluetooth application system of the HDD 1 has means for reading the BD address and the PIN from the first flash ROM 25.

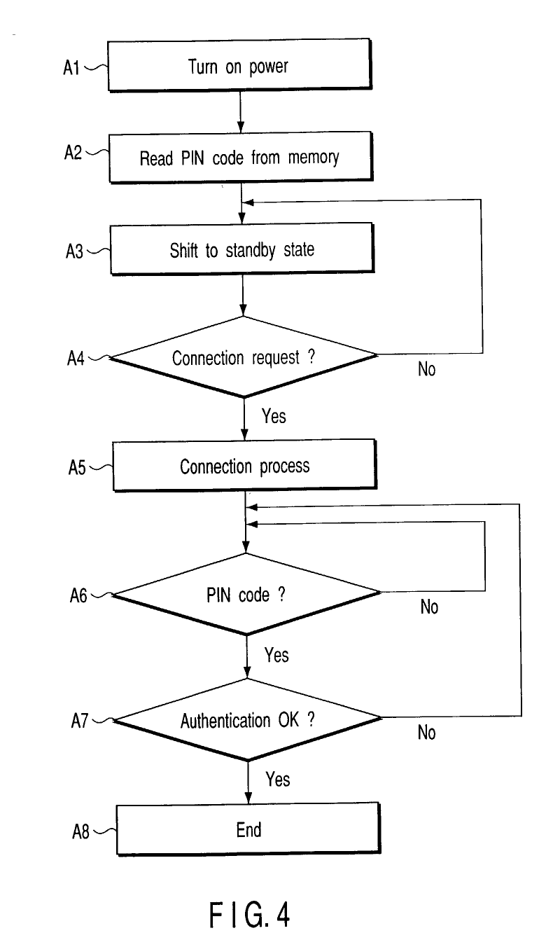

An operation of the HDD 1 of the above embodiment, at a time when the HDD 1 is connected to the first PC 2, will be described with reference to the flowchart shown in FIG. 4. FIG. 4 shows a process in the case where only the PIN is prestored in the first flash ROM 25 of the SD card 4.

When the power source of the HDD 1 is turned on in a step A1 in FIG. 4, the CPU 13 reads a program from the flash ROM 15, and reads the PIN from the first flash ROM 25 of the SD card 4 in a step A2. When the reading of the PIN is completed, the CPU 13 sends a command to shift in a standby state to the BT controller 23 in a step A3.

In this state, the first PC 2 sends an inquiry and a call to the HDD 1. Thereafter, when the first PC 2 sends a connection request to the HDD 1 in a step A4, the CPU 13 executes a connection response in a step A5 and the connection is completed. If there is no connection request from the first PC 2 in the step A4, the flow returns to the step A3 and the HDD 1 is set in the standby state. Thus, the HDD 1 is always on standby.

After completion of the connection to the first PC 2, the CPU 13 of the HDD 1 determines whether the PIN is sent from the first PC 2 (step A6). If it is determined that the PIN is sent, the flow advances to a next step A7, in which an authentication process is performed. In the authentication process, an initialization key is generated from the PIN that has been read from the first flash ROM 25, thereby setting a link key. The initialization key is generated by using a random number generated by the HDD 1.

In the authentication process after the link key is set, authentication of both the first PC 2 and the HDD 1 must be carried out. If both authentication processes succeed, the flow advances to a step A8. Thereafter, the first PC 2 recognizes the HDD 1 as a removable device by the upper protocol stacks and the File Transfer profile.

When the authentication of either the HDD 1 or the PC 2 fails, the flow returns to the step A6, and the HDD 1 stands by until it receives a next PIN.

With the above method, the HDD 1 can be authenticated each time it receives a PIN, without requiring a manual input of the PIN. Therefore, the security can be improved without impairing the convenience.

Although the PIN is used as an authentication code in the above embodiment, the authentication process may be carried out by using a BD address instead of the PIN.

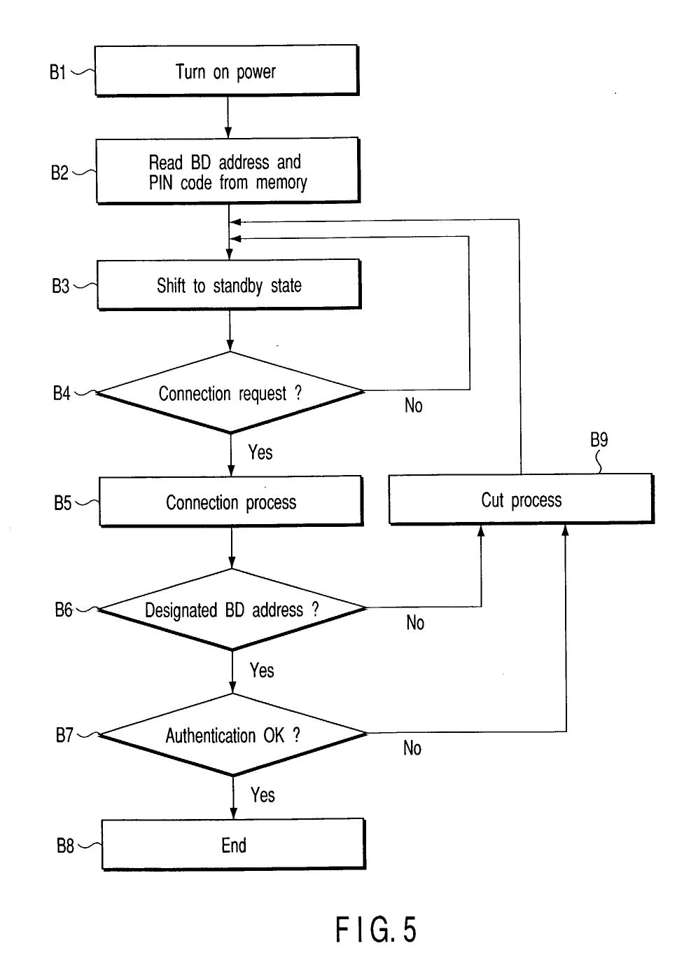

An operation, in the case where the first flash ROM 25 of the SD card 4 prestores a BD address and a PIN corresponding to the BD address, will be described with reference to the flowchart shown in FIG. 5.

When the power source of the HDD 1 is turned on in a step B1 in FIG. 5, the CPU 13 reads a program from the flash ROM 15, and reads the BD address and the PIN from the first flash ROM 25 of the SD card 4 in a step B2. When the reading of the BD address and the PIN is completed, the CPU 13 sends a command to shift in a standby state to the BT controller 23 in a step B3.

In this state, the first PC 2 sends an inquiry and a call to the HDD 1. Thereafter, when the first PC 2 sends a connection request to the HDD 1 in a step B4, the CPU 13 executes a connection response in a step B5 and the connection is completed. If there is no connection request from the first PC 2 in the step B4, the flow returns to the step B3 and the HDD 1 is set in the standby state. Thus, the HDD 1 is always on standby.

After the completion of the connection, the CPU 13 determines whether the BD address sent from the first PC 2 matches the BD address that has been read from the first flash ROM 25 (step B6). If the BD addresses do not match, the flow advances to a step B9, in which the CPU 13 cuts the connection requesting device, i.e., the first PC 2, in this case. Then, the flow returns to the step B3, in which the HDD 1 is set in the standby state. If the BD addresses match, the flow advances to a next step B7, in which an authentication process is performed. In the authentication process, an initialization key is generated from the PIN that has been read from the first flash ROM 25, and a link key is set. The initialization key is generated by using a random number generated by the HDD 1.

In the authentication process after the link key is set, authentication of both the first PC 2 and the HDD 1 must be carried out. If both authentication processes succeed, the flow advances to a step B8. Thereafter, the first PC 2 recognizes the HDD 1 as a removable device by the upper protocol stacks and the File Transfer profile.

If the authentication of either the first PC 2 or the HDD 1 fails, the flow advances to the step B9, in which the CPU 13 cuts the connection requesting device. Then, the flow returns to the step B3, in which the HDD 1 is set in the standby state.

With the above method, all connections by a BD address other than the designated BD address are cut, and the HDD 1 can be authenticated each time it receives a BD address and a PIN, without requiring a manual input of them. Therefore, the security can be improved without impairing the convenience. In addition, since connection from an unauthorized device is automatically cut, the number of the upper limit of the slave devices (eight), which can be connected in compliance with Bluetooth, is not reduced by unauthorized connection.

In the above embodiment, the HDD 1 is used as an external device main body. However, the removable medium is not limited to the HDD, but may be any medium, such as a CD-ROM, a CD-R, a DVD-ROM, a DVD-RAM and MO, Smartmedia, and a semiconductor medium such as an SD memory card.

Since the BD address is a unique address, it is required that a plurality of BD addresses and PINs be registered.

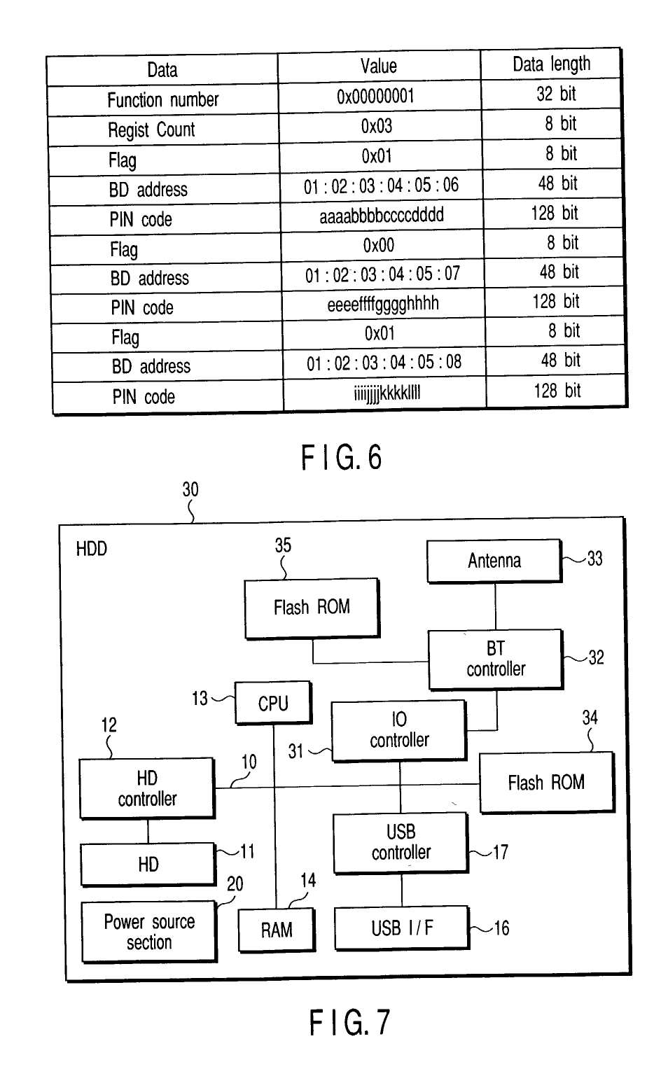

FIG. 6 shows a data format for registration of a plurality of BD addresses. In FIG. 6, Function number indicates the type of data subsequent to the function number. In this case, the value “0x00000001” indicates information related to BD addresses and PINs.

Regist Count data indicates the number of registered BD addresses and PINs. The value “0x03” indicates that three pieces of data are recorded.

Flag indicates whether connection is permitted or prohibited (whether a connection request should be ignored). The value “0x01” means that connection is permitted, while the value “0x00” means that connection is prohibited. In FIG. 6, the first flag is “0x01”, which means that the BD address “01:02:03:04:05:06” is a connection-permitted address.

PIN code “aaaabbbbccccdddd” is a value which should be determined in accordance with the value of the BD address.

Since the next flag is “0x00”, the BD address “01:02:03:04:05:07” is not a connection-permitted address. Accordingly, the PIN “eeeeffffgggghhhh” is ignored.

Since the next flag is “0x01”, the BD address “01:02:03:04:05:08” is a connection-permitted address. The PIN is “iiiijjjjkkkkllll”. The above are the three pieces of data indicated by the value of Regist Count.

With the format as described above, since a plurality of BD addresses and PINs can be registered, connection from a designated device having an arbitrary BD address can be permitted.

(Second Embodiment)

In the first embodiment, the SD card 4 including the Bluetooth function is inserted in the HDD 1, whereas, in the second embodiment, the Bluetooth function is incorporated in an external device main body, an HDD, without using an SD card 4. BD addresses and PINs can be written in the HDD through a USB interface or the like.

FIG. 7 is a block diagram showing an example of the structure in which the Bluetooth function is incorporated in an external HDD. Referring to FIG. 7, an external HDD 30 including the Bluetooth function in its main body includes an HD 11, an HD controller 12, a CPU 13, a RAM 14, a USB interface 16, a USB controller 17, an IO controller 31, a BT controller 32, an antenna 23, a first flash ROM 34 and a second flash ROM 35.

The functions of the HD 11, the HD controller 12, the CPU 13, the RAM 14, the USB interface 16 and the USB interface 17 are the same as those of the first embodiment, and detailed descriptions thereof are omitted.

The IO controller 31 is executes bus conversion between the CPU 13 and the BT controller 32. The BT controller 32, the antenna 33, the first and second flash ROMs 34 and 35 have the same functions as those of the BT controller 23, the antenna 24, the first and second flash ROMs 25 and 26 of the SD card 4 shown in FIG. 3.

The first flash ROM 34 prestores one or both of the BD addresses and the PINs. A device, such as a PC or a PDA, can write data into the first flash ROM 34 through the USB interface 16. The second flash ROM 35 stores programs which the BT controller 32 uses. When the power source is turned on, the BT controller 32 reads a program from the second flash ROM 35, and executes the corresponding process.

The BT controller 32 has protocols in compliance with Bluetooth, such as HCI (Host Controller Interface), LM (Link Manager) and Baseband. The BT controller 32 processes control data from the host and outputs it as a high-frequency output to the antenna 33. It also processes a high-frequency signal from the antenna 33 and inputs/outputs control data or user data to/from the IO controller 31.

The CPU 13 reads a BD address and a PIN from the first flash ROM 34, so that verification of the BD address and authentication by the PIN can be carried out after connection with another Bluetooth device is completed.

As described above, the BD addresses and the PINs are written in the first flash ROM 34 of the HDD 30. With this structure, the connection process and the authentication process according to the first embodiment, shown in the flowchart of FIG. 4 or FIG. 5, can be carried out without using an SD card. Thus, the same effect as that of the first embodiment can be obtained.

The device, which normally does not have a user interface, has been described above. However, the present invention can also be applied to a PDA, a PC or a cellular phone, which has a user interface. In this case also, a high level of security is retained.

(Third Embodiment)

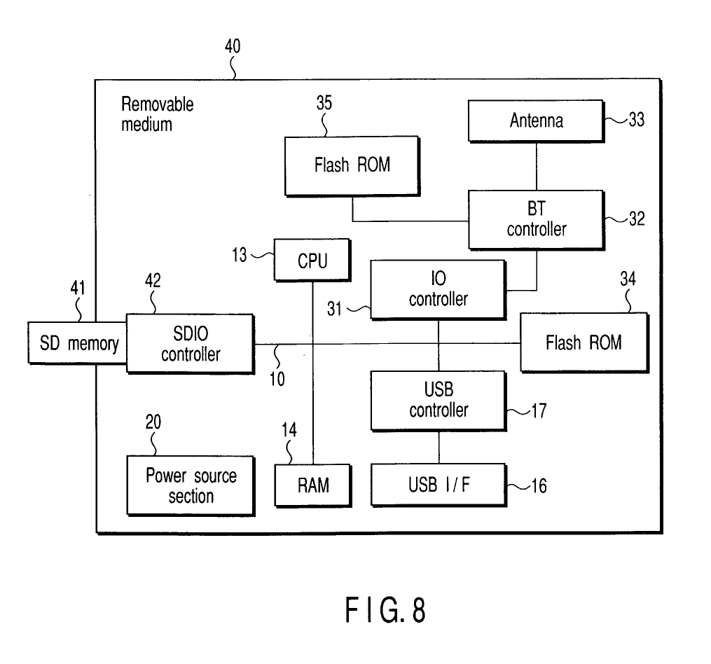

A third embodiment of the present case will now be described with reference to FIG. 8. According to the third embodiment, the present invention is applied to a removable medium using an SD memory.

Referring to FIG. 8, a removable medium 40 includes a SD memory 41 removably inserted therein and an SDIO controller 42, i.e., an interface for the memory. The SDIO controller 42 is connected to a bus line 10. In the removable medium 40, data can be read/written in/from the SD memory 41 in compliance with Bluetooth. The CPU 13, the RAM 14, the USB interface 16, the USB interface 17, the IO controller 31, the BT controller 32, the antenna 33, the first and second flash ROMs 34 and 35 are the same as the corresponding elements shown in FIG. 7, and detailed descriptions thereof are omitted.

In this embodiment, the BD addresses and the PINs are stored in the SD memory 41, not in the first flash ROM 34. They are read by the CPU 13 through the SDIO controller and an authentication process is carried out.

As described above, the BD addresses and the PINs are written in the SD memory 41 of the removable medium 40. With this structure, the connection process and the authentication process according to the first embodiment, shown in the flowchart of FIG. 4 or FIG. 5, can be carried out.

With this method, since an arbitrary PIN can be set for each medium to be read (SD memory 41), a very high level of security is set.

In this embodiment, the SD memory 41 is used as a removable medium. However, the BD addresses and the PINs may be prestored in a media card or a flash memory connected to the USB cable, and read therefrom. In this case also, the same effect can be obtained.

In the above embodiments, Bluetooth is used as wireless communication means. However, any other wireless communication means can be used, in which case the same effect can be obtained by using ID codes or passwords in place of the BD addresses and PINs.

As has been described in detail, according to the present invention, a peripheral of a personal computer or the like is provided with a wireless communication function and authentication codes are prestored in the memory. When a connection request from another electronic apparatus is received, the authentication codes stored in the memory are read, so that authentication can be carried out. Therefore, the authentication can be carried out even in the electronic apparatus to which an authentication code cannot be input. Thus, the security can be improved. Moreover, since it is unnecessary to manually input an authentication code, the convenience can also be improved.

Further, when wireless communication is carried out in compliance with Bluetooth, connection by a BD address other than the registered BD address is not permitted. Furthermore, authentication using PINs is carried out. Thus, a high-security level system can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main body; and
a communication device which is removably attached to the main body, the communication device including an antenna, a communication unit which executes communication with another electronic apparatus via the antenna, a memory which stores an authentication code, and an authenticating unit which reads the authentication code stored in the memory and executes an authentication process using the authentication code when the communication with the another electronic apparatus is executed by the communication unit.

2. The electronic apparatus according to claim 1, wherein the communication unit executes communication in compliance with Bluetooth.

3. The electronic apparatus according to claim 1, wherein the communication unit executes communication in compliance with Bluetooth using at least one of a Bluetooth address and a PIN (Personal Identification Number) as the authentication code.

4. The electronic apparatus according to claim 1, wherein the communication unit executes communication in compliance with Bluetooth using a Bluetooth address and a PIN (Personal Identification Number) as the authentication code.

5. The electronic apparatus according to claim 1, further comprising an interface to write an identification code in the memory.

6. An electronic apparatus comprising:
a hard disk drive;
an antenna provided to the hard disk drive;
a communication unit which executes communication with another electronic apparatus via the antenna;
a memory which stores an authentication code; and
an authenticating unit which reads the authentication code stored in the memory and executes an authentication process using the authentication code when the communication with the another electronic apparatus is executed by the communication unit.

7. The electronic apparatus according to claim 6, wherein the communication unit executes communication in compliance with Bluetooth.

8. The electronic apparatus according to claim 6, wherein the communication unit executes communication in compliance with Bluetooth using at least one of a Bluetooth address and a PIN (Personal Identification Number) as the authentication code.

9. The electronic apparatus according to claim 6, wherein the communication unit executes communication in compliance with Bluetooth using a Bluetooth address and a PIN (Personal Identification Number) as the authentication code.

10. The electronic apparatus according to claim 6, further comprising an interface to write an identification code in the memory.

11. An electronic apparatus comprising:
a main body;
a hard disk drive;
an antenna provided to the hard disk drive;
a communication unit which executes communication with another electronic apparatus via the antenna;
a memory card which is removably attached to the main body and stores an authentication code; and
an authenticating unit which reads the authentication code stored in the memory card and executes an authentication process using the authentication code when the communication with the another electronic apparatus is executed by the communication unit.

12. The electronic apparatus according to claim 11, wherein the communication unit executes communication in compliance with Bluetooth.

13. The electronic apparatus according to claim 11, wherein the communication unit executes communication in compliance with Bluetooth using at least one of a Bluetooth address and a PIN (Personal Identification Number) as the authentication code.

14. The electronic apparatus according to claim 11, wherein the communication unit executes communication in compliance with Bluetooth using a Bluetooth address and a PIN (Personal Identification Number) as the authentication code.

15. The electronic apparatus according to claim 11, further comprising an interface to write an identification code in the memory.

16. A wireless communication system comprising:
a communication unit which executes wireless communication with another electronic apparatus in compliance with Bluetooth;
a memory which stores at least one of a Bluetooth address and a PIN (Personal Identification Number); and
an authenticating unit which executes an authentication process using the at least one of the Bluetooth address and the PIN, when the communication unit receives a connection request from the another electronic apparatus.

17. The wireless communication system according to claim 16, wherein the at least one of the Bluetooth address and the PIN is stored in a memory device which is removably attached to an electronic apparatus.

18. A wireless communication system comprising:
a communication unit which executes wireless communication with another electronic apparatus in compliance with Bluetooth;
a memory which stores a Bluetooth address and a PIN (Personal Identification Number) according to the Bluetooth address; and
an authenticating unit which, when the communication unit receives a connection request from the another electronic apparatus, executes a connection cut process if the connection request is a request by a Bluetooth address other than the Bluetooth address stored in the memory, and executes an authentication process using the PIN stored in the memory if the connection request is a request by the Bluetooth address stored in the memory.

19. The wireless communication system according to claim 18, wherein the Bluetooth address and the PIN are stored in a memory device which is removably attached to an electronic apparatus.
